(19) United States
(12) Patent Application Publication
(10) Pub. No.: US 2013/0210358 A1
(43) Pub. Date: Aug. 15, 2013

(54) Application Control Method and Mobile Electronic Device thereof

(71) Applicant: HTC Corporation, (US)

(72) Inventors: Peter Chou, Taoyuan County (TW); Drew Bamford, Bellevue, WA (US); John C. Wang, Taoyuan County (TW); Huang-Chi Chou, Taoyuan County (TW); Sung-Ming Chin, Taoyuan County (TW)

(73) Assignee: HTC CORPORATION, Taoyuan County (TW)

(21) Appl. No.: 13/756,419

(22) Filed: Jan. 31, 2013

Related U.S. Application Data
(60) Provisional application No. 61/597,848, filed on Feb. 13, 2012.

(51) Int. Cl. H04B 7/26

(52) U.S. Cl. CPC H04B 7/26
USPC 455/41.2

(57) ABSTRACT

By checking a type of a foreground application of a mobile electronic device in response to an instruction triggered on a Bluetooth device and transmitted to the mobile electronic device in a wireless manner, a function of the foreground application will be executed corresponding to the instruction, where the type of the foreground application may be optionally switched before executing the function.

### CROSS REFERENCE TO RELATED APPLICATIONS

This application claims priority of U.S. Provisional Application No. 61/597,848 filed on Feb. 13, 2012.

### BACKGROUND OF THE INVENTION

1. Field of the Invention

The present invention relates to an application control method and a mobile electronic device thereof, and more particularly, an application control method of determining whether to execute a function of a foreground application according to a type of the foreground application and a mobile electronic device utilizing the application control method.

2. Description of the Prior Art

A conventional mobile electronic device, such as a smart-phone, introduces lots of functions. Mobile electronic device may also support other input/output devices for specific tasks. For example, a Bluetooth headset may be used to pick up an incoming call. However, such input/output device can only serve predetermined single or limited applications running on the mobile device. To meet needs of various applications, multiple input/output device need to be purchased by the user. This may add up the cost and inconvenience of carrying many devices. On the other hand, not every application is supported by dedicated input/output device. Operations of such applications must be performed via the native input/output interface of the mobile electronic device, for example touch screen. Therefore, it would be beneficial to user to reused existing input/output device for other non-supported applications.

### SUMMARY OF THE INVENTION

The claimed invention discloses an application control method of a mobile electronic device. The method comprises mapping at least one key of a Bluetooth device to correspond to operations of at least two applications installed on a mobile electronic device; receiving a Bluetooth signal corresponding to the key from the Bluetooth device; converting the Bluetooth signal to a Bluetooth command; checking a type of a foreground application running on the mobile electronic device; and executing an operation corresponding to the Bluetooth command according to the type of the foreground application; wherein the at least two applications comprise at least one first application natively supported by the Bluetooth device and at least one second application originally not supported by the Bluetooth device.

The claimed invention further discloses an application control method of a mobile electronic device. The method comprises configuring at least one Bluetooth key of a Bluetooth device to support at least a phone application and a non-phone application installed on a mobile electronic device; receiving a Bluetooth signal corresponding to the Bluetooth key from the Bluetooth device;

checking a type of a foreground application activated on the mobile electronic device; and determining and executing an operation corresponding to the Bluetooth signal according to the type of the foreground application.

The claimed invention discloses a mobile electronic device. The mobile electronic device comprises a Bluetooth interface module configured to receive a Bluetooth signal corresponding to a key of a Bluetooth device and to convert the Bluetooth signal into a Bluetooth command; an application status register configured to store a foreground application status the mobile electronic device; and a processor configured to execute at least two applications installed on the mobile electronic device, to map the key of the Bluetooth device to operations of the two applications respectively; and to execute one of the operations corresponding to the Bluetooth command according to the foreground application status; wherein at least one of the applications is not originally supported by the Bluetooth device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a mobile electronic system according to one embodiment of the present invention.

FIG. 2 illustrates the application control method of the present invention according to one embodiment of the present invention.

### DETAILED DESCRIPTION

For facilitating a user of a mobile electronic device in using functions provided by various applications, the present invention discloses an application control method and a mobile electronic device utilizing the application control method. With the aid of the disclosed application control method and the disclosed mobile electronic device of the present invention, a user of the mobile electronic device may use functions of applications installed on the mobile electronic device with simplified operations, such as a single press.

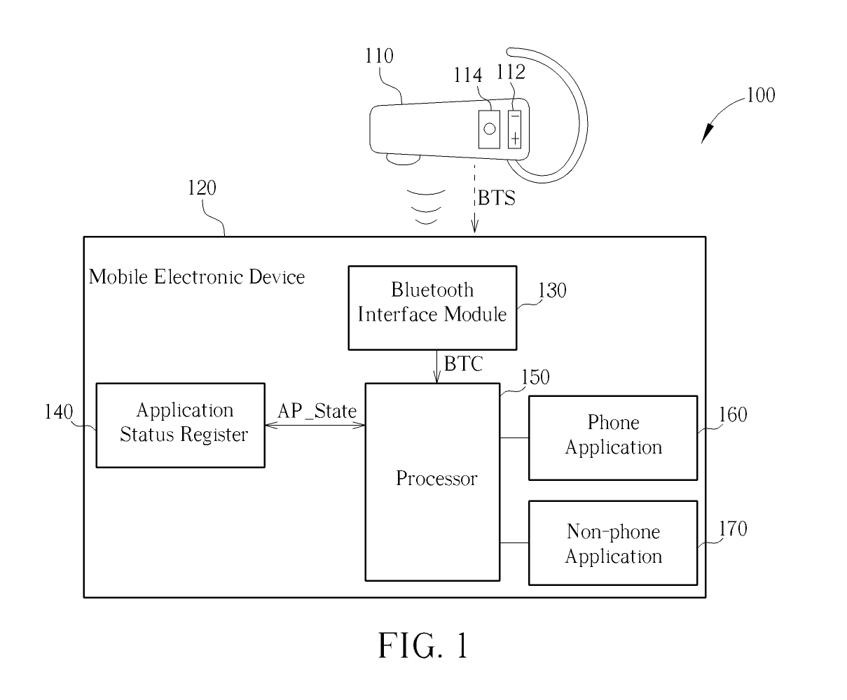

Please refer to FIG. 1, which illustrates a mobile electronic system 100 according to one embodiment of the present invention. As shown in FIG. 1, the mobile electronic system 100 includes a Bluetooth device 110 and a mobile electronic device 120.

The Bluetooth device 110 includes a volume rocker button 112 and an activation button 114, and the Bluetooth device 110 is also configured to transmit a Bluetooth signal BTS in response to an instruction received via at least one press on the volume rocker button 112 or the activation button 114. The Bluetooth device 100 may be originally used for controlling operation of a phone application 160.

The mobile electronic device 120 includes a Bluetooth interface module 130, an application status register 140, and a processor 150. At least two applications, including a phone application 160 and a non-phone application 170, are assumed to be installed on the mobile electronic device 120 and executed by the processor 150. The Bluetooth interface module 130 is configured to receive the Bluetooth signal BTS from the Bluetooth device 110 in a wireless manner. The application status register 140 is configured to monitor an application status AP_state indicating a type or name of a currently utilized foreground application of the mobile electronic device 120.

Generally, the processor 150 may run the phone application 160 and when a phone call is received by the mobile electronic device 120, a user of the mobile electronic device 120 could pick up the phone call by pressing the activation button 114 of the Bluetooth device 110. The Bluetooth device 110 would send a Bluetooth signal BTS corresponding to the activation button 114 to the Bluetooth interface module 130, and the Bluetooth interface module 130 then converts the Bluetooth signal BTS into a Bluetooth command BTC and transmits to the phone application 160. Since the primary function of the Bluetooth device 110 is to support hand-free conversation of phone application 160, the activation button 114 corresponds to a command of answering the phone call, the volume rocker button 112 corresponds to another command of tuning volume up or down. Conventionally, in a case that the phone application 160 is not running in the foreground, or says no phone call is received or dialed, the Bluetooth signal BTS transmitted from the Bluetooth device 110 is discarded. In the present invention, the user of the mobile electronic device 100 may configure functions of the Bluetooth device 110 to support operations of other non-phone application 170, such as a camera application or video application. The activation button 114 and the volume rocker button 112 can be reconfigured to correspond to operations of the non-phone application 170.

In one embodiment of the invention, the non-phone application 170 is a camera application, and the volume rocker button 112 is reconfigured to correspond to zoom-in/out operation and the activation button 114 is reconfigured as camera shutter. When the camera application is launched, i.e. running as foreground application, Bluetooth signal BTS from the activation button 114 is converted into camera capture event and transmit to the camera application for executing related operation. The Bluetooth command BTC can be converted by the phone application 160 or other control module executed by the processor 150. In one embodiment of the invention, upon receiving the Bluetooth command BTC, the phone application 160 checks with the application status register 140 to determine which application is currently running in the foreground. The application status register 140 would monitor status change of foreground application, and sends application status signal AP_State to the processor 150. In response to the application status signal AP_state indicates that the current foreground application is the camera application, the Bluetooth command BTC is converted to a camera event. In response to the current foreground application is neither the camera application nor the phone application 160, the Bluetooth command BTC will be discarded.

Please note that due to the phone application 160 has higher priority than non-phone application 170, in the case that the foreground application is the camera application and an incoming call is received by the mobile electronic device 120, the Bluetooth signal BTS from the Bluetooth device 110 would be processed to correspond to operations of phone application 160 regardless the foreground application is camera application. And the application status register 140 updates the foreground application to the phone application 160 until the phone call is finished. In one embodiment of the invention, the application status register 140 may also record the previous foreground application so that it can be switched back upon termination of the phone application 160.

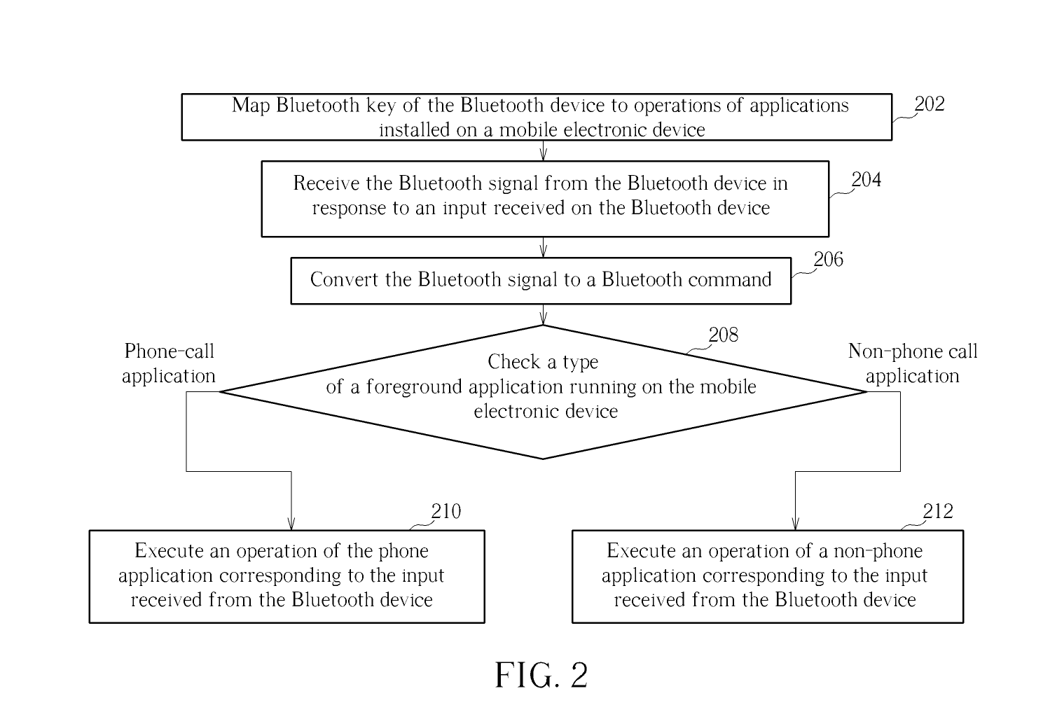

The Processor 150 is configured to perform primary steps of the application control method of the present invention, and processing flow of the processor 150 will be further described in FIG. 2.

Please refer to FIG. 2, which illustrates the application control method of the present invention according to one embodiment of the present invention. Note that the steps shown in FIG. 2 may be performed by the mobile electronic system 100 shown in FIG. 1. As shown in FIG. 2, the application control method includes the following steps:

Step 202: Map Bluetooth key of the Bluetooth device 110 to operations of applications installed on the mobile electronic device 120.

Step 204: Receive the Bluetooth signal BTS from the Bluetooth device 110 by the mobile electronic device 120 in response to an input received on the Bluetooth device 110.

Step 206: Convert the Bluetooth signal BTS to a Bluetooth command BTC.

Step 208: In response to the Bluetooth command BTC, check a type of a foreground application running on the mobile electronic device 120. If the type of the foreground application is a phone application 160, go to Step 210; else, if the type of the foreground application is a non-phone application 170, go to Step 212.

Step 210: Execute an operation of the phone application 160 on the mobile electronic device 120 corresponding to the input received from the Bluetooth device 110.

Step 212: Execute an operation of a non-phone application 170 on the mobile electronic device 120 corresponding to the input received from the Bluetooth device 110.

The following steps will be described by two exemplary embodiments, with respect to different user experiences.

### (1) First Embodiment

In the first embodiment, a user of the mobile electronic system 100 is assumed to receive a hint of phone call, for example, the mobile electronic device 120 rings or vibrates itself. The mobile electronic device 120 then switches its current foreground application from the non-phone application 170 to the phone application 160 in a way that a user interface of the phone application 160 is displayed on the mobile electronic device 120 for example in a pop-up manner. Note that a type of the foreground application indicated by the application status AP_state stored in the application status register 140 is immediately changed from the non-phone application 170 to the phone application 160 when the mobile electronic device 120 receives the phone call.

In Step 202, a Bluetooth key of the Bluetooth device 110 is required to be mapped to operation of applications installed on the mobile electronic device 120 by the processor 150 in advance, so that the mobile electronic device 120 is capable of recognizing any Bluetooth signal transmitted from the Bluetooth device 110.

In Step 204, a user of the mobile electronic system 100 may be aware of the hint given by the mobile electronic device 120 to answer a phone call. The user may tap on the volume rocker button 112 or the activation button 114 to give an instruction of answering the phone call. Then the Bluetooth device 110 transmits the Bluetooth signal BTS in a wireless manner in response to the input.

In Step 206, the Bluetooth interface module 130 receives the Bluetooth signal BTS and convert the Bluetooth signal BTS into the Bluetooth command BTC corresponding to the Bluetooth signal BTS. Note that in one embodiment Step 202 is required for performing Step 206 due to the Bluetooth interface module 130 is not capable of converting the Bluetooth signal BTS into the Bluetooth command BTC without the Bluetooth key being configured on the mobile electronic device 120. In another embodiment, the mobile electronic device is pre-configured to support dedicated functions of the Bluetooth device 110.

In Step 208, the processor 150 checks the type of the foreground application currently running on the mobile electronic device 120 by referencing to the application status AP_state stored by the application status register 140. In the first embodiment, since the currently-running foreground application is the phone application 160, Step 210 is then performed to execute an answer operation of the phone application 160 for answering the phone call.

In one embodiment of the present invention, the user may also tap the activation button 114 for hanging up the phone call. For example, in Step 208, since the current foreground application is still the phone call application 160, Step 212 will be performed for executing a hang-up operation of the phone application 160.

Note that operation of the phone application 160 may be corresponding to different combinations of the buttons on the Bluetooth device 110, where related combinations are not limited to the abovementioned description.

### (2) Second Embodiment

In the second embodiment, the user of the mobile electronic system 100 is assumed to intend to launch the non-phone application 170, such as camera application or video recording application. Note that the type of the foreground application indicated by the application status AP_state stored in the application status register 140 is the non-phone application 170.

In the second embodiment, Step 202, Step 204, Step 206 are performed in a same way as in the first embodiment so that repeated description are saved for brevity.

In Step 208, the processor 150 checks the application status register 140 and confirms that the current foreground application is the non-phone application 170. Then Step 212 is performed for executing a specific operation corresponding to input received from the Bluetooth device 110.

In one embodiment of the present invention, the non-phone application 170 may be a video recording application. Therefore, when the video recording application is the foreground application running on the mobile electronic device 120, a tap on the ‘+’ sign or the ‘−’ sign of the volume rocker button 112 may be utilized to indicate a zoom-in instruction, a zoom-out instruction, a volume-up instruction, or a volume-down instruction for zooming-in, zooming-out, volume-up, or volume-down a video to be recorded by the video recording application in Step 212; and a tap on the activation button 114 may be utilized to indicate a video shutter instruction for starting or stopping a video recording function of the video recording application in Step 212, similar as a home screen function or a screen lock function. There may also be an additional button disposed on the Bluetooth device 110 configured to launch the video recording application on the mobile electronic device 120. Note that the functions of the video recording application may be implemented by software or hardware of the mobile electronic device 120.

In one embodiment of the present invention, the non-phone application 170 may be a camera application. Therefore, when the camera application is the foreground application of the mobile electronic device 120, a tap on the ‘+’ sign or the ‘−’ sign of the volume rocker button 112 may be utilized to indicate a zoom-in instruction or a zoom-out instruction for zooming-in or zooming-out an image to be captured by the camera application in Step 212; and a tap on the activation button 114 may be utilized to indicate a camera shutter instruction for starting or stopping a camera shooting operation of the camera application in Step 212. For example, when the camera application is the foreground application of the mobile electronic device, a user of the mobile electronic system 100 may press and hold the activation button 112 for performing a continuous camera shooting operation of the camera application, and may then release the activation button 112 for stopping the continuous camera shooting operation. There may also be an additional button disposed on the Bluetooth device 110 configured for launching the camera application on the mobile electronic device 120. Note that the functions of the camera application may be implemented by software or hardware of the mobile electronic device 120.

In embodiments of the present invention, operations or instructions corresponding to the buttons on the Bluetooth device 110 are not limited as shown in FIG. 1; numbers or dispositions of the buttons on the Bluetooth devices are not limited as shown in FIG. 1; and a type of the Bluetooth device 110 is not also limited to a headset as shown in FIG. 1.

Embodiments formed by reasonable combinations or permutations and/or by adding any of the abovementioned limitations should also be regarded as embodiments of the present invention.

The present invention discloses an application control method and a mobile electronic system utilizing the application control method. With the aid of the disclosed application control method and the disclosed mobile electronic system, a user may benefit from easily triggering a function of a currently-utilized foreground application.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An application control method of a mobile electronic device, comprising:
mapping at least one key of a Bluetooth device to correspond to operations of at least two applications installed on a mobile electronic device;
receiving a Bluetooth signal corresponding to the key from the Bluetooth device;
converting the Bluetooth signal to a Bluetooth command;
checking a type of a foreground application running on the mobile electronic device; and
executing an operation corresponding to the Bluetooth command according to the type of the foreground application;
wherein the at least two applications comprise at least one first application natively supported by the Bluetooth device and at least one second application originally not supported by the Bluetooth device.

2. The method of claim 1, wherein executing the operation corresponding to the Bluetooth command according to the type of the foreground application comprises:
executing the operation corresponding to the first application natively supported by the Bluetooth device in response to the foreground application is the first application.

3. The method of claim 1, wherein executing the operation corresponding to the Bluetooth command according to the type of the foreground application comprises:
executing the operation corresponding to the second application natively supported by the Bluetooth device in response to the foreground application is the second application.

4. The method of claim 1, wherein the Bluetooth device is a Bluetooth headset and the first application is a phone application.

5. The method of claim 4, wherein the second application is a camera application and the step of executing the operation corresponding to the Bluetooth command according to the type of the foreground application further comprises:
executing a camera shooting operation in response to the foreground application is the camera application.

6. The method of claim 5, wherein the step of executing the operation corresponding to the Bluetooth command according to the type of the foreground application further comprises:
executing a camera zoom-in or zoom-out operation in response to the foreground application is the camera application.

7. An application control method of a mobile electronic device, comprising:
configuring at least one Bluetooth key of a Bluetooth device to support at least a phone application and a non-phone application installed on a mobile electronic device;
receiving a Bluetooth signal corresponding to the Bluetooth key from the Bluetooth device;
checking a type of a foreground application activated on the mobile electronic device; and
determining and executing an operation corresponding to the Bluetooth signal according to the type of the foreground application.

8. The method of claim 7, wherein determining and executing an operation corresponding to the Bluetooth signal according to the type of the foreground application comprises:
executing the operation of the phone application in response to the foreground application is determined as the phone application.

9. The method of claim 8, wherein determining and executing an operation corresponding to the Bluetooth signal according to the type of the foreground application comprises:
executing the operation of the non-phone application in response to the foreground application is the non-phone application.

10. The method of claim 9, wherein the non-phone call application is a video recording application or a camera application.

11. The method of claim 10, wherein the operation is a camera shooting operation, and the Bluetooth signal corresponds to an activation key of the Bluetooth device.

12. The method of claim 10, wherein the operation is a zoom-in/out operation, and the Bluetooth signal corresponds to a volume rocker key of the Bluetooth device.

13. The method of claim 7, wherein the phone application has higher priority than the non-phone application, and the method further comprises:
executing the operation of the phone application in response to the foreground application is the non-phone application.

14. A mobile electronic device, comprising:
a Bluetooth interface module, configured to receive a Bluetooth signal corresponding to a key of a Bluetooth device and to convert the Bluetooth signal into a Bluetooth command;
an application status register, configured to store a foreground application status the mobile electronic device; and
a processor, configured to execute at least two applications installed on the mobile electronic device, to map the key of the Bluetooth device to operations of the two applications respectively; and to execute one of the operations corresponding to the Bluetooth command according to the foreground application status;
wherein at least one of the applications is not originally supported by the Bluetooth device.

15. The mobile electronic device of claim 14, wherein the at least two applications comprise a phone application and a non-phone application.

16. The mobile electronic device of claim 15, wherein the processor is further configured to execute the operation corresponding to the phone application in response to the foreground application is the phone application.

17. The mobile electronic device of claim 15, wherein the processor is further configured to execute the operation corresponding to the non-phone application in response to the foreground application is the non-phone application.

18. The mobile electronic device of claim 15, wherein the non-phone application is a camera application.

19. The mobile electronic device of claim 18, wherein the operation corresponding to the Bluetooth command is a camera shooting operation in response to the key is an activation key, and the operation corresponding to the Bluetooth command is a zoom-in/out operation in response to the key is a volume rocker key.
